(19) United States
(12) Patent Application Publication
(10) Pub. No.: US 2010/0231444 A1
(43) Pub. Date: Sep. 16, 2010

(54) POSITIONING RECEIVER AND POSITIONING METHOD

(75) Inventors: Akifumi Miyano, Yokohama-shi (JP); Hiroshi Katayama, Yokohama-shi (JP); Kazuhiro Nojima, Yokohama-shi (JP); Hirofumi Yoshida, Yokohama-shi (JP); Kei Murayama, Sendai-shi (JP)

Correspondence Address: Seed Intellectual Property Law Group PLLC, 701 Fifth Avenue, Suite 5400, Seattle, WA, 98104, US

(73) Assignee: PANASONIC CORPORATION, Kadoma-shi, Osaka (JP)

(21) Appl. No.: 12/739,946

(22) PCT Filed: Apr. 26, 2007
(86) PCT No.: PCT/JP2007/070932

§ 371 Date: Apr. 26, 2010

(51) Int. Cl. G01S 19/42

(52) U.S. Cl. 342/357.25

(57) ABSTRACT

A positioning receiver and method in which the time required for signal acquisition can be reduced and positioning time can be reduced by increasing the occasion of the signal acquisition. In an SPS receiver mounted user equipment (100), a Doppler shift amount measuring means (112a) of a frequency search range control unit (112) measures the Doppler shift amount of the signals from a plurality of base stations of a communication network. A search range control means (112b) calculates the difference between the maximum value and minimum value of the measured Doppler shift amount of the base stations and determines the search range at the time of satellite signal search by comparing the difference and a predetermined threshold. The search range control means (112b), if it is judged that the difference between the maximum value and minimum value of the Doppler shift amount is larger than the threshold, sets the search range larger and, if not, sets the search range less.

### TECHNICAL FIELD

The present invention relates to a positioning receiving apparatus and a positioning method for quickly capturing positioning satellite signals of a satellite positioning system.

### BACKGROUND ART

In recent years, a vehicle navigation apparatus in which a receiving apparatus of a satellite positioning system (“SPS”) that is typically a GPS (Global Positioning System) is mounted, and a mobile communication terminal apparatus with an SPS receiving apparatus such as a mobile telephone apparatus with an SPS receiving function, have come into practical use.

There are cases where, unlike a car, a mobile communication terminal apparatus in particular such as a mobile telephone apparatus with an SPS receiving function that guides a walking route for people moves indoors, and therefore is required to have higher sensitivity to support positioning indoors. Preferably, an SPS receiving apparatus with higher sensitivity has an accurate frequency clock source inside. Therefore, in a conventional mobile telephone apparatus with an SPS receiving function, the clock source of the communication section that is synchronized with a base station in a mobile telephone communication network corrects the frequency of the clock source of the SPS receiving apparatus, to an accurate frequency.

It is widely practiced that a mobile communication terminal in which such a positioning function is mounted adopts a crystal oscillator as the part of the apparatus for generating clock signals (hereinafter “GPS clock signals”) to use in receiving processing for GPS signals because crystal oscillators are reasonable (see, for example, Patent Document 1).

However, the oscillation frequency of a crystal oscillator fluctuates depending on the condition of use such as the temperature of the surrounding, and therefore a wider search frequency range needs to be set, and, as a result, there are cases where it takes time to capture signals. Conventionally, this conventional proposal discloses using clock signals of high frequency accuracy acquired when wireless communication is performed between a mobile communication terminal and a wireless base station on the ground, and detecting how much the frequencies of GPS clock signals generated in the crystal oscillator inside the mobile communication terminal deviate from ideal values. Then, signal processing related to positioning is performed based on the difference between those frequencies. By so doing, even if the frequencies of GPS clock signals (hereinafter “GPS clock frequencies”) generated in the crystal oscillator are different from the ideal values, it is possible to capture signals at high speed by limiting the frequency search range.

FIG. 1 shows a configuration of a conventional mobile telephone apparatus with an SPS receiving function.

In FIG. 1, mobile telephone apparatus with SPS receiving function 10 has SPS antenna 11, SPS receiving section 12, SPS clock source 13, wireless communication section antenna 14, frequency error calculating section 15, frequency controlling section 16, wireless communication section clock source 17, frequency comparing section 18, frequency correction controlling section 19, search frequency controlling section 20 and positioning calculating section 21.

SPS receiving section 12 performs reception processing for SPS signals received at SPS antenna 11. SPS receiving section 12 searches for and captures SPS signals, and acquires information included in the SPS signals. To be more specific, SPS receiving section 12 performs code synchronization by performing satellite search for SPS signals from satellites received as input from SPS antenna 11, based on the search frequencies set in search frequency controlling section 20. SPS receiving section 12 has a plurality of channels for performing the same operations.

SPS clock source 13 outputs signals of a specific operation frequency for operating SPS receiving section 12.

Frequency error calculating section 15 receives at wireless communication section antenna 14 a signal from a base station in the wireless communication network, and calculates a frequency error in wireless communication section clock source 17 based on the frequency of this signal.

Frequency controlling section 16 outputs a signal for controlling the frequency in wireless communication section clock source 17 based on the calculated frequency error.

Wireless communication section clock source 17 outputs signals having an operation frequency matching the control signal.

Frequency comparing section 18 compares the frequency in wireless communication section clock source 17 with the frequency in SPS clock source 13. Frequency comparing section outputs information about the difference between the frequencies of the SPS clock and the cellular clock.

Frequency correction controlling section 19 corrects the SPS search frequencies based on the result of comparing frequencies in frequency comparing section 18.

Search frequency controlling section 20 performs frequency control for searching for SPS signals. Search frequency controlling section 20 determines the frequency (i.e. search reference frequency) that plays the major role to perform satellite search, based on information about the frequency error from frequency correction controlling section 19. The frequencies for searching for satellites are sequentially set based on the search reference frequency. The number of frequencies for performing searches is set according to the number of channels in which SPS receiving section 12 can perform search at the same time. The frequencies are changed until code synchronization is finished in the channels of SPS receiving section 12.

Positioning calculating section 21 performs positioning calculation based on information for capturing satellites such as code phases upon code synchronization between a plurality of channels performed in SPS receiving section 12, frequencies and signal levels, and outputs a positioning result.

According to the above configuration, mobile telephone apparatus 10 having a positioning receiving apparatus compares a clock signal which is outputted from wireless communication section clock source 17 and which is based on an accurate signal from the base station, with a frequency signal of SPS clock source 13, and thereby frequency correction controlling section 19 corrects a search frequency, so that SPS receiving section 12 can perform search based on the accurate frequency.

### Patent Document 1: Japanese Patent Application Laid-Open No. 2003-329761

### DISCLOSURE OF INVENTION

### Problems to be Solved by the Invention

However, such a conventional mobile communication terminal apparatus with a positioning receiving apparatus has the following problem.

A place where positioning satellite signal search in a mobile communication terminal apparatus is performed cannot always be a spot of a good environment for satellite signals, and it is required to capture signals quickly by narrowing the frequency search range. The search range is determined by considering various factors of frequency errors, and one of these factors is frequency Doppler shift due to movement of the mobile communication terminal apparatus. At timing when a mobile communication terminal apparatus starts capturing SPS signals, whether or not the mobile communication terminal apparatus is moving is not known, and therefore it is necessary to set the search range taking into account the Doppler shift frequency at the maximum possible speed. Even in case where the mobile communication terminal apparatus is not moving, search is performed in a search range reflecting the Doppler shift produced at the maximum possible moving speed, and therefore there is a problem that it takes time to perform search.

FIG. 2 shows transition of the search frequency according to a conventional positioning satellite signal searching method.

In FIG. 2, the horizontal axis indicates the time [sec] having passed from the time when search started, and the vertical axis indicates the frequency [ppm]. In the frequency domain, fs is the frequency of a satellite signal transmitted from a satellite, and fo is the search reference frequency. The search reference frequency (fo) is set apart from the satellite signal frequency (fs), and the mobile communication terminal (i.e. mobile telephone apparatus 10) performs search by gradually shifting search target frequency 20 to surrounding frequency bands over time based on the satellite signal frequency (fs). The search range (Δf) is determined because it takes more time to perform search if the search range is made wider.

Frequency comparing section 18 of mobile telephone apparatus with SPS receiving function 10 in FIG. 1 corrects SPS clock source 13 based on the accurate reference clock signal of wireless communication section clock source 107 synchronized with the base station in the communication network to determine the search reference frequency (fo).

The search range (Δf) is determined by reflecting all factors of frequency errors. The main factors of frequency errors are an SPS clock source correction error and Doppler shift due to the movement of the mobile communication terminal. In case of FIG. 2, the search range (Δf) is formed with the search range reflecting Doppler shift (see FIG. 2a) due to movement of the mobile communication terminal, and the search range reflecting a GPS clock source correction error (see FIG. 2b).

Note that the SPS clock source correction error is determined based on the frequency error from the base station in the communication network, and based on the frequency synchronization accuracy of frequency control processing by frequency error calculating section 15, frequency controlling section 16 and wireless communication section clock source 17 shown in FIG. 1

The Doppler shift due to the movement of the mobile communication terminal is determined by assuming the maximum moving speed taking into account the situation in which the user uses a mobile communication terminal. For example, the maximum moving speed is about 100 kilometers per hour (about 0.1 ppm) in case where use in a car is assumed, and is 300 kilometers per hour (about 0.3 ppm) in case where movement using a train is taken into account.

Positioning satellite signal search is performed by increasing and decreasing the amplitude of search frequencies based on the search reference frequency (fo) and switching between the search frequencies. The width of change in the search frequency is determined based on the frequency range that can be monitored by one search. When the search frequency reaches the search range (Δf), the search frequency is reset to the reference frequency and then the frequency is switched between an upper frequency and a lower frequency to perform search.

If the SPS signal level is low, there are cases where signals cannot be detected even when the search frequency and SPS signal satellite frequency match. Therefore, in order to reduce the time to capture SPS signals, it is important to increase the number of searches per unit time and increase opportunities for detecting SPS signals.

A method of narrowing a search range is possible as one of methods of increasing the number of searches. However, because whether the mobile communication terminal is moving is not known, search also needs to be performed at all times in a search range reflecting Doppler shift at the maximum possible moving speed, and, therefore, this raised a problem that wasteful search is performed if the mobile communication terminal is not moving, thereby delaying the detection of SPS signals.

That is, search needs to be performed in a frequency range that takes the maximum speed into account at all times because the moving speed is not known, and therefore the sensitivity, time required for positioning and positioning rate are limited. For example, even if narrow band search is to be performed, a search also needs to be performed in a search range reflecting Doppler shift (±600 Hz and 0.38 ppm) due to movement of the mobile communication terminal (for example, 400 kilometers per hour).

In view of the above, it is therefore an object of the present invention to provide a positioning receiving apparatus and a positioning method that reduce the time required to capture signals by increasing opportunities for capturing signals and that reduce the time required for positioning.

### Means for Solving the Problem

The positioning receiving apparatus according to the present invention employs a configuration which includes: a Doppler shift amount measuring section that measures amounts of Doppler shift of signals from a plurality of base stations; a search range controlling section that controls a search range for positioning satellite signal search, based on the measured amounts of Doppler shift of the signals from the plurality of base stations; and a satellite signal searching section that searches for positioning satellite signals in a frequency search range determined in the search range controlling section.

The positioning method according to the present invention includes: measuring amounts of Doppler shift of signals from a plurality of base stations; determining a search range for positioning satellite signal search, based on the measured amounts of Doppler shift of the signals from the plurality of base stations; and searching for positioning satellite signals in a determined frequency search range.

### ADVANTAGEOUS EFFECTS OF INVENTION

According to the present invention, by controlling a search range based on the amounts of Doppler shift of signals from a plurality of base stations, it is possible to increase opportunities for capturing signals when the terminal is not moving and consequently reduce the time required to capture signals and reduce the time required for positioning.

### BRIEF DESCRIPTION OF DRAWINGS

FIG. 1 shows a configuration of a conventional mobile telephone apparatus with an SPS receiving function;

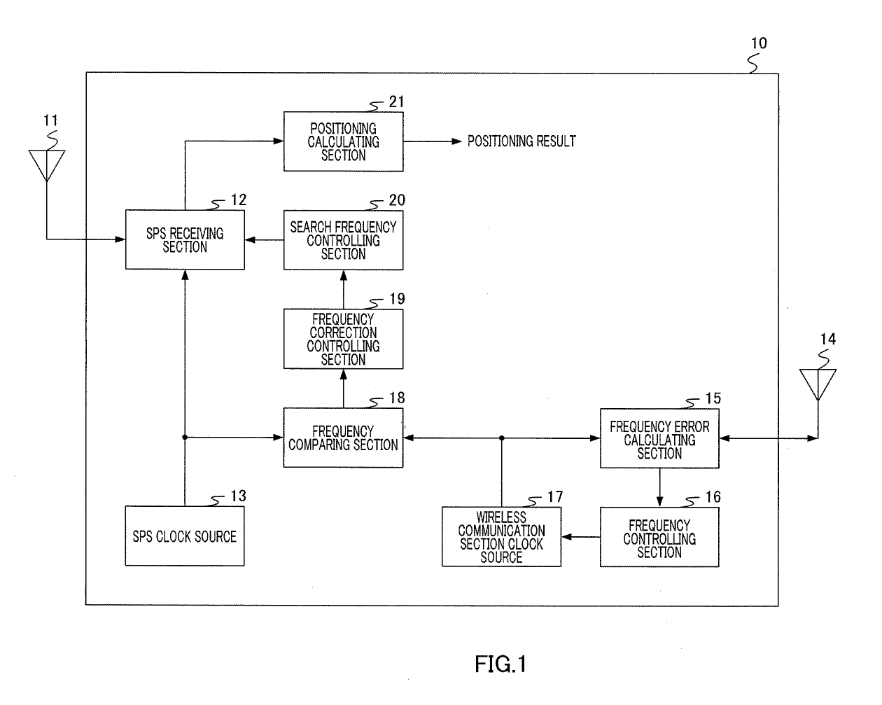

FIG. 2 shows transition of a search frequency according to a conventional positioning satellite signal searching method;

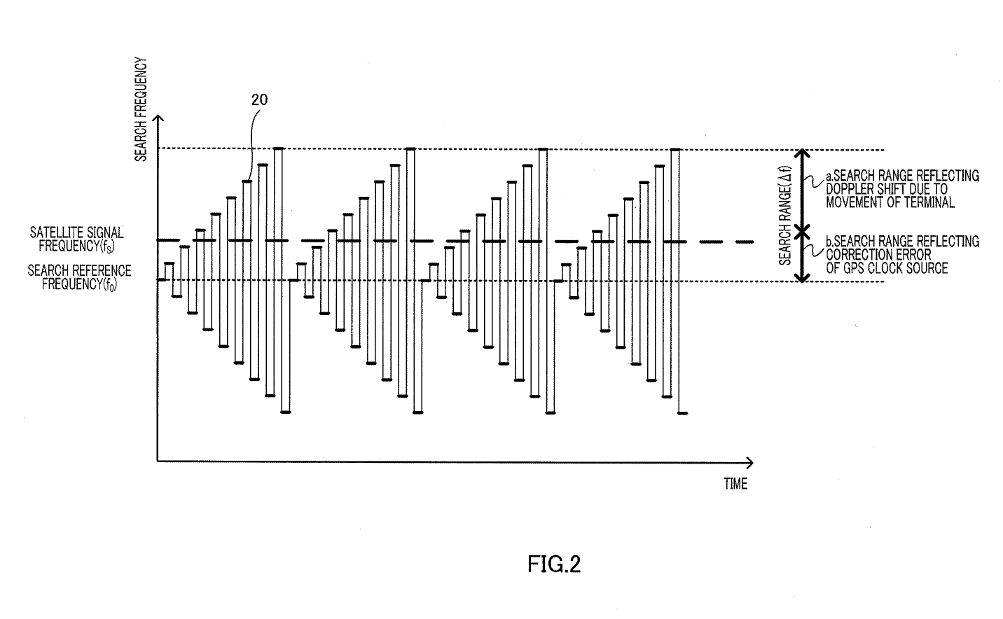

FIG. 3 shows a configuration of a mobile communication terminal apparatus with a positioning receiving apparatus according to Embodiment 1 of the present invention;

FIG. 4 is a flowchart showing satellite signal search processing in the above mobile communication terminal apparatus with the positioning receiving apparatus according to Embodiment 1;

FIG. 5 illustrates that frequencies of base stations change in the above mobile communication terminal apparatus with the positioning receiving apparatus according to Embodiment 1;

FIG. 6 shows changes in search frequencies according to the positioning satellite signal searching method in the above mobile communication terminal apparatus with the positioning receiving apparatus according to Embodiment 1;

FIG. 7 shows a configuration of a mobile communication terminal apparatus with a positioning receiving apparatus according to Embodiment 2 of the present invention;

FIG. 8 shows a configuration of a mobile communication terminal apparatus with a positioning receiving apparatus according to Embodiment 3 of the present invention;

FIG. 9 shows a configuration of a mobile communication terminal apparatus with a positioning receiving apparatus according to Embodiment 4 of the present invention; and

FIG. 10 shows a configuration of a mobile communication terminal apparatus with a positioning receiving apparatus according to Embodiment 5 of the present invention.

### BEST MODE FOR CARRYING OUT THE INVENTION

Hereinafter, the positioning receiving apparatus, mobile terminal apparatus and positioning method according to embodiments of the present invention will be explained in detail with reference to the accompanying drawings.

### Embodiment 1

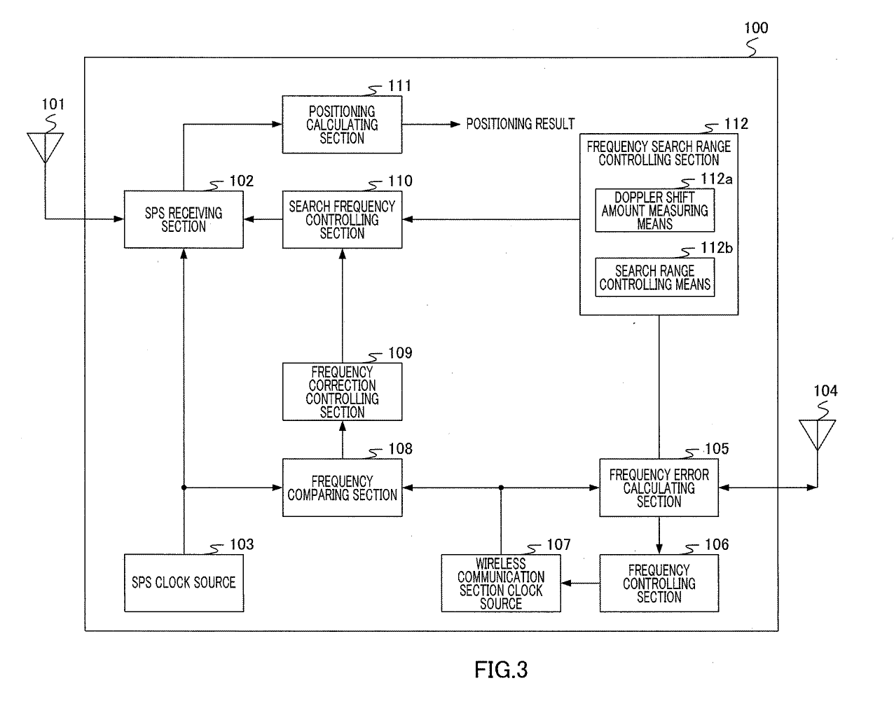

FIG. 3 shows a configuration of a mobile communication terminal apparatus with a positioning receiving apparatus according to Embodiment 1 of the present invention. The present embodiment provides an example where a positioning receiving apparatus is applied to a mobile communication terminal apparatus with an SPS receiving apparatus.

In FIG. 3, SPS receiving apparatus mounting mobile communication terminal apparatus 100 has SPS antenna 101, SPS receiving section 102, SPS clock source 103, wireless communication section antenna 104, frequency error calculating section 105, frequency controlling section 106, wireless communication section clock source 107, frequency comparing section 108, frequency correction controlling section 109, search frequency controlling section 110, positioning calculating section 111 and frequency search range controlling section 112.

SPS receiving apparatus mounting mobile communication terminal apparatus 100 is a mobile telephone with an SPS receiving function, or a vehicle navigation apparatus. SPS receiving apparatus mounting mobile communication terminal apparatus 100 is a mobile communication terminal that has: a function to connect to a wireless base station; and a positioning function based on an SPS receiving system, and is formed with: a CPU; a storing medium such as ROM that stores a control program; a working storage area such as RAM; and a communication circuit as existing hardware (all of these components are not shown). In SPS receiving apparatus mounting mobile communication terminal apparatus 100, the CPU executes the control program to implement the functions of the above parts of the apparatus.

SPS receiving section 102 performs reception processing of SPS signals received at SPS antenna 101. SPS receiving section 102 searches for and captures SPS signals, and acquires information included in the SPS signals. To be more specific, SPS receiving section 102 performs code synchronization by performing satellite search for the SPS signals from satellites received as input from SPS antenna 101, based on the search frequencies set in search frequency controlling section 110. SPS receiving section 102 has a plurality of channels for performing the same operations.

SPS clock source 103 outputs signals of a specific operation frequency for operating SPS receiving section 102. SPS clock source 103 generates SPS clock signals used as operation clocks for SPS receiving section 102, using a temperature compensated crystal oscillator (“TCXO”) (not shown). SPS receiving section 102 is a free-running clock source that does not establish frequency synchronization unlike an AFC apparatus in frequency error calculating section 105 of SPS receiving apparatus mounting mobile communication terminal apparatus 100. Further, although a crystal oscillator is a temperature-compensated type, the oscillation frequency of a crystal oscillator fluctuates by the influence of temperature in the surroundings. Accordingly, the accuracy of the frequency of an SPS clock signal is lower than the accuracy of the frequency of the reference clock signal of frequency error calculating section 105 that has established frequency synchronization with the wireless base station apparatus.

Frequency error calculating section 105 receives at wireless communication section antenna 104 a signal from a base station in the wireless communication network, and calculates a frequency error in wireless communication section clock source 107 based on the frequency of the signal. Frequency error calculating section 105 has an AFC (Automatic Frequency Control) apparatus that has a PLL (Phase-Locked Loop) circuit (not shown), and establishes frequency synchronization with the carrier frequencies of radio signals transmitted from the wireless base station to improve cellular clocks generated in wireless communication section clock source 107. Based on signals from a plurality of base stations in the communication network, frequency error calculating section 105 can calculate errors in wireless communication section clock source 107 upon using base stations individually. By this means, it is possible to calculate differences between the wireless communication section clock and frequencies of a plurality of base stations.

Frequency controlling section 106 controls the frequency of wireless communication section clock source 107 to correct the calculated frequency errors.

Wireless communication section clock source 107 outputs signals of an operation frequency matching the control signals.

Frequency comparing section 108 compares the frequency of wireless communication section clock source 107, which is an accurate signal synchronized with the signal of the base station of the communication network, with the frequency of SPS clock source 103. Frequency correction controlling section 108 determines the reference frequency for SPS signal search from the result of comparing the frequency for outputting information about a difference between frequencies of the SPS clock and the cellular clock.

Frequency correction controlling section 109 corrects the SPS search frequency based on the frequency comparison result from frequency comparing section 108.

Around the SPS search reference frequency determined in frequency correction controlling section 109, search frequency controlling section 110 performs search from an upper frequency to a lower frequency in the frequency search range determined in frequency search range controlling section 112. Search frequency controlling section 110 determines the frequency (i.e. search reference frequency) that plays a major role to perform satellite search, based on information about the frequency difference from frequency correction controlling section 109. The frequencies for searching for satellites are determined sequentially based on the search reference frequency. The number of frequencies for performing search is set according to the number of channels in which SPS receiving section 102 can perform search at the same time. The frequency for performing search is changed until code synchronization in each channel is finished in SPS receiving section 102.

Positioning calculating section 111 calculates positioning information such as the location and speed, based on the SPS satellite signal received in SPS receiving section 102. Positioning calculating section 111 performs positioning calculation based on information for capturing satellites such as code phases upon code synchronization between a plurality of channels performed in SPS receiving section 102, frequencies and signal levels.

Frequency search range controlling section 112 has: Doppler shift amount measuring means 112a that measures the amounts of Doppler shift of signals from a plurality of base stations in the communication network; and search range controlling means 112b that controls the search range for positioning satellite signal search, based on the measured amounts of Doppler shift of the signals from a plurality of base stations, and determines the frequency search range upon SPS signal search utilizing information of the frequency of each base station. Search frequency controlling section 110 searches for positioning satellite signals in the frequency search range determined in frequency search range controlling section 112. The details of the search range determining method will be described later.

Doppler shift amount measuring means 112a measures variations of the received frequencies between base stations as the amounts of Doppler shift.

Search range controlling means 112b performs search range controls for narrowing the search range when variations of the frequencies between base stations indicated by the measured amounts of Doppler shift of signals from a plurality of base stations are significant, and for widening the search range when variations of the frequencies between base stations are little. Search range controlling means 112b decides the variations of frequencies between base stations by comparing the amounts of Doppler shift with a predetermined threshold. To be more specific, search range controlling means 112b performs controls for narrowing the positioning satellite search range (a) in case where the difference between the minimum value and the maximum value of the measured amounts of Doppler shift of signals from a plurality of base stations is equal to or less than a threshold, (b) in case where the standard deviation of the measured amounts of Doppler shift of signals from a plurality of base stations is equal to or less than a threshold or (c) in case where the distribution of the measured amounts of Doppler shift of signals from a plurality of base stations is equal to or less than a threshold.

Hereinafter, the operation of SPS receiving apparatus mounting mobile communication terminal apparatus 100 configured as described above will be explained.

[Satellite Signal Searching Operation of Mobile Communication Terminal Apparatus 100]

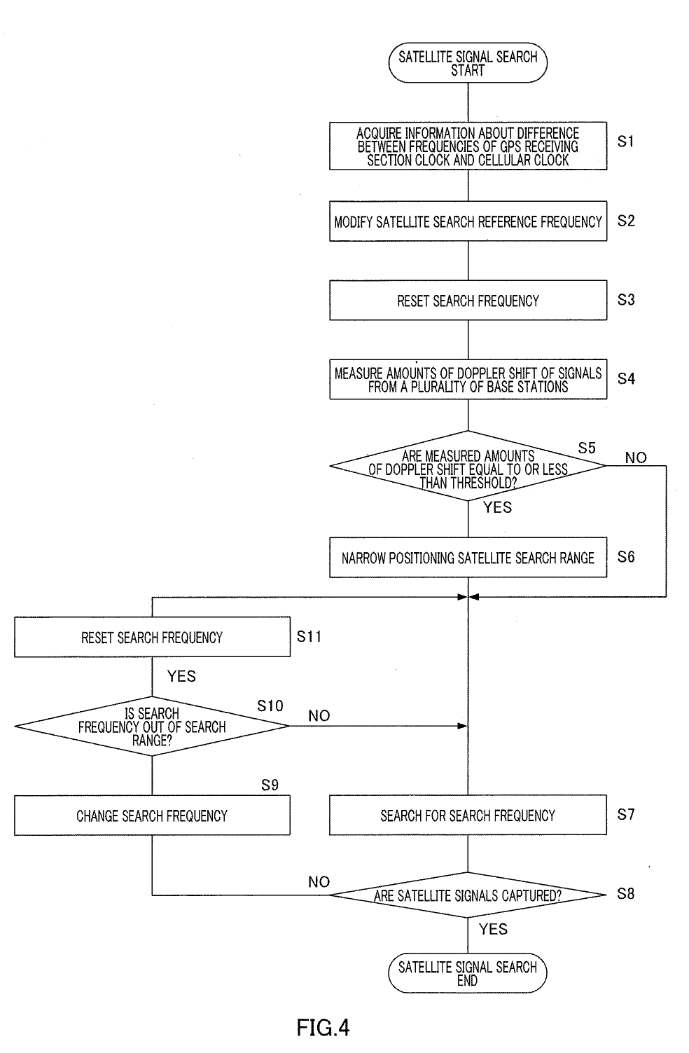

FIG. 4 is a flowchart showing satellite signal search processing by SPS receiving apparatus mounting mobile communication terminal apparatus 100.

First, in step S1, frequency comparing section 108 acquires information about the difference between frequencies of an SPS clock and a cellular clock. The clock frequency difference can be calculated by, for example, counting how many times an SPS clock signal rises in a period in which a reference clock signal rises a predetermined number of times and comparing an actual count value with a count value acquired if the SPS clock frequency is an ideal value.

In step S2, frequency correction controlling section 109 modifies satellite search reference frequency fs based on the acquired frequency difference information.

In step S3, search frequency controlling section 110 resets the search frequency once.

In step S4, Doppler shift amount measuring means 112a of frequency search range controlling section 112 measures the amounts of Doppler shift of signals from a plurality of base stations.

In step S5, search range controlling means 112b of frequency search range controlling section 112 decides whether or not the measured amounts of Doppler shift of signals from a plurality of base stations are equal to or less than a threshold.

If the measured amounts of Doppler shift of signals from a plurality of base stations are equal to or less than a threshold, in step S6, search range controlling means 112b performs controls for narrowing the positioning satellite search range based on the decision that variations of frequencies between base stations are significant. With the present embodiment, search range controlling means 112b performs controls for narrowing the positioning satellite search range if the difference between the minimum value and the maximum value of the measured amounts of Doppler shift of signals from a plurality of base stations is equal to or less than the threshold. Naturally, the decision may be made based on whether or not the standard deviation of the measured amounts of Doppler shift of signals from a plurality of base stations is equal to or less than a threshold, or whether or not distribution of the measured amounts of Doppler shift of signals from a plurality of base stations is equal to or less than a threshold.

If the measured amounts of Doppler shift of signals from a plurality of base stations are greater than the threshold, the step proceeds to step S7 maintaining a wide search range without changing the positioning satellite search range based on the decision that the variations of frequencies from base stations are little.

In step S7, around the SPS search reference frequency determined in frequency correction controlling section 109, search frequency controlling section 110 performs search from an upper frequency to a lower frequency in the frequency search range determined in frequency search range controlling section 111.

In step S8, SPS receiving section 102 decides whether or not a satellite signal is captured, and, if the satellite signal is captured, the flowchart is finished assuming that satellite signal search is finished. Search for SPS signals is finished, for example, when code synchronization can be established with a number of SPS satellites required for positioning or when code synchronization cannot be established with a plurality of SPS satellites required for positioning even though search is performed in a predetermined search range.

If satellite signals cannot be captured, search frequency controlling section 110 changes the search frequency in step S9, and SPS receiving section 102 decides whether or not the search frequency is outside the search range in step S10. If the search frequency is outside the search range, search frequency controlling section 110 resets the search frequency in step S11, and proceeds to step S7 to perform search using the search frequency in step S7. Further, if the search frequency is not outside the search range, the step proceeds to step S7 to perform search based on the search frequency in step S7.

[Search Range Determining Method]

Next, the search range determining method of frequency search range controlling section 112 will be explained.

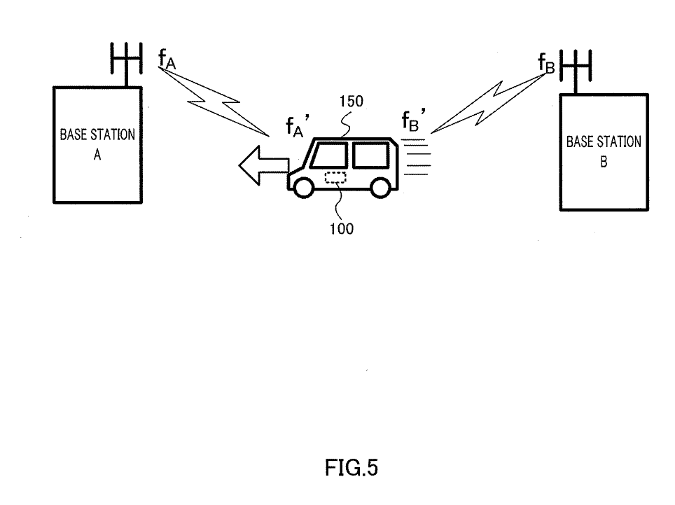

FIG. 5 explains the change of frequencies of base stations. In FIG. 5, SPS receiving apparatus mounting mobile communication terminal apparatus 100 is a vehicle navigation apparatus installed in vehicle 150, or a mobile telephone with an SPS receiving function that the user riding on vehicle 150 carries. Further, SPS receiving apparatus mounting mobile communication terminal apparatus 100 performs wireless communication with base station A and base station B. Now, vehicle 150 is moving fast from base station B to base station A.

Frequency error calculating section 105 of SPS receiving apparatus mounting mobile communication terminal apparatus 100 of FIG. 3 calculates frequency errors in wireless communication section clock source 107 based on signals of a plurality of base stations. In other words, frequency error calculating section 105 calculates the frequency of each base station based on the frequency of wireless communication section clock source 107. If SPS receiving apparatus mounting mobile communication terminal apparatus 100 is moving, due to Doppler shift, the frequency of each base station has different Doppler shift according to the location of each base station and the moving speed of the terminal.

Assume that, as shown in, for example, FIG. 5, base station A is arranged ahead the direction in which SPS receiving apparatus mounting mobile communication terminal apparatus 100 moves, and base station B is arranged in the rear of this direction, and signals having frequencies f_{A} and f_{B} are outputted from these base stations. In this case, SPS receiving apparatus mounting mobile communication terminal apparatus 100 observes from base station A received frequency f_{A}′ higher than oscillation frequency f_{A} and from base station B received frequency f_{B}′ lower than oscillation frequency f_{B}. The ratios (f_{A}′/f_{A} and f_{B}′/f_{B}) of these oscillation frequencies (f_{A} and f_{B}) and received frequencies (f_{A}′ and f_{B}′) are determined based on the relationship between the positions of the terminal and the base station, and, as shown in FIG. 5, the ratio of f_{A} and f_{A}′ is substantially different from the ratio of f_{B} and f_{B}′. By calculating and comparing the ratio (hereinafter, “the amount of Doppler shift”) of the oscillation frequency and received frequency of each base station, it is possible to decide whether or not SPS receiving apparatus mounting mobile communication terminal apparatus 100 is moving or is not moving. A terminal (here, SPS receiving apparatus mounting mobile communication terminal apparatus 100) knows the oscillation frequency of each base station in a general communication network, so that it is possible to calculate the amount of Doppler shift by measuring the received frequency.

With the present embodiment, Doppler shift amount measuring means 112a of frequency search range controlling section 112 measures the amounts of signals from a plurality of base stations in the communication network, search range controlling means 112b calculates the difference between the maximum value and the minimum value of the measured amounts of Doppler shift from a plurality of base stations and compares this difference with a predetermined threshold, so that SPS receiving apparatus mounting mobile communication terminal apparatus 100 determines the search range upon satellite signal search. When deciding that the difference between the maximum value and the minimum value of the amounts of Doppler shift is greater than the threshold, search range controlling means 112b sets a wide search range taking into account the Doppler shift due to the movement of SPS receiving apparatus mounting mobile communication terminal apparatus 100, and, when deciding that the difference between the maximum value and the minimum value of the amounts of Doppler shift is smaller than the threshold, sets a narrow search range. Because frequency errors that base stations in the communication network cause are generally designated by the specification, this designated value or a value multiplying the designated value with a constant may be used for the threshold. However, the present invention is not limited to this.

Further, search range controlling means 112b of frequency search range controlling section 112 may compare the standard deviation of the amounts of Doppler shift of a plurality of base stations, with a threshold, and sets a wide search range when the standard deviation of the amounts of Doppler shift is greater than the threshold or sets a narrow search range when the standard deviation of the amounts of Doppler shift is equal to or less than the threshold.

Furthermore, search range controlling means 112b of frequency search range controlling section 112 compares the distribution of the amounts of Doppler shift of a plurality of base stations, and sets a wide search range when the distribution of the amounts of Doppler shift is greater than the threshold or sets a narrow search range when the distribution of the amounts of Doppler shift is equal to or less than the threshold.

Note that the threshold to be compared with the difference between the maximum value and the minimum value, the standard deviation or distribution of the measured amounts of Doppler shift is not limited to one threshold, and it is equally possible to provide a plurality of thresholds and set a search range with respect to each threshold. It is preferable to provide a table of search ranges matching the thresholds.

The determinants for the search range mainly include a correction error of SPS clock source 103, and Doppler shift due to movement of the terminal. In case of the configuration of FIG. 3, a correction error of SPS clock source 103 is corrected using the clock of wireless communication section clock source 107 synchronized with the signal of each base station. However, this correction reflects the frequency error that each base station originally causes, a synchronization error of wireless communication section clock source 107, a frequency comparison error in frequency comparing section 108 and so on. A wide search range is set by, for example, adding the frequency reflecting the correction error of SPS clock source 103 and the search range reflecting Doppler shift due to the movement of the terminal. By contrast with this, a narrow search range is set only with, for example, the search range reflecting the correction error of SPS clock source 103. Although, as the search range reflecting Doppler shift, it may be possible to add the search range reflecting Doppler shift matching the maximum speed by assuming the situation in which the user uses the terminal, the present invention is not limited to this.

Although a configuration has been explained with the present embodiment where SPS clock source 103 is corrected using clocks of wireless communication section clock source 107, in case where such correction is not performed, it is possible to use a search range reflecting a frequency error prior to correction that SPS clock source 103 originally causes, instead of the search range reflecting a correction error in SPS clock source 103.

The method of setting a search range by threshold comparison has been explained above. A method of setting a search range by applying to a given equation the difference between the maximum value and the minimum value, standard deviation and distribution of the amounts of Doppler shift without providing the threshold is possible. The equation used in this case is equation 1. Equation 1 is one example.

Search range=α×D+β (Equation 1)

α and β: constant
D: the difference between the maximum value and the minimum value of the amounts of Doppler shift, standard deviation of the amounts of Doppler shift, or distribution of the amounts of Doppler shift

The values of α and β are set such that, when D takes the maximum value, D becomes the same value as the wide search range set by comparing D with the threshold, and, when D takes the minimum value, D becomes the same value as the narrow search range. Further, it is equally possible to provide a limiter function to forcibly set a wide search range when D exceeds a wide search range set by comparing D with the threshold according to above equation 1, and forcibly set a narrow search range when D goes below the narrow search range.

Next, the searching operations in case where a wide search range is set and in case where a narrow search range is set will be explained.

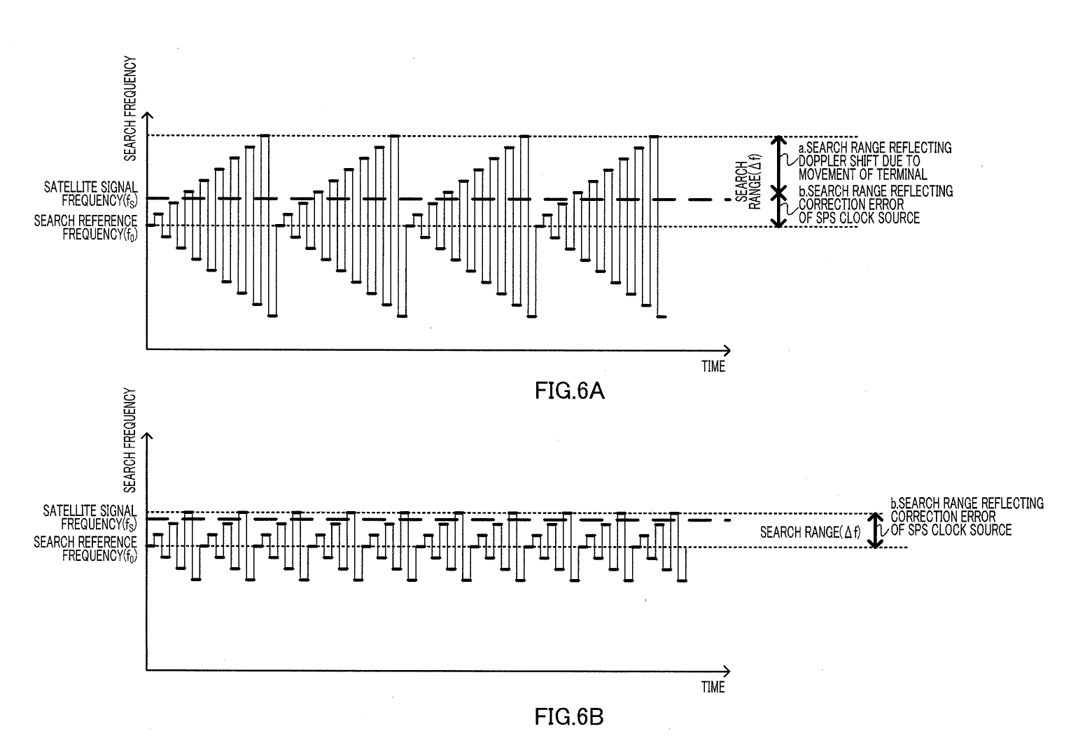

FIG. 6 shows the change of the search frequency according to the positioning satellite signal searching method in SPS receiving apparatus mounting mobile communication terminal apparatus 100. In FIG. 6, the horizontal axis indicates the time [sec] having passed from the time when search started, and the vertical axis indicates the frequency [ppm]. FIG. 6 also shows the satellite signal frequency (fs), the search reference frequency (fo) and the search range (Δf).

FIG. 6A shows the positioning satellite signal searching operation in case where the search range (Δf) is wide, and FIG. 6B shows the positioning satellite signal searching operation in case where the search range (Δf) is narrowed.

In case where the above search range (Δf) is wide, the moving speed of SPS receiving apparatus mounting mobile communication terminal apparatus 100 is fast, and, accordingly, variations of frequencies between base stations indicated by the amounts of Doppler shift are significant. In case where the above search range (Δf) is narrowed, the moving speed of SPS receiving apparatus mounting mobile communication terminal apparatus 100 is slow, and, accordingly, variations of frequencies between base stations indicated by the amounts of Doppler shift are little. Search range controlling means 112b controls the search range to determine the search range based on the amounts of Doppler shift due to the movement of SPS receiving apparatus mounting mobile communication terminal apparatus 100.

While, in case where the search range (Δf) of FIG. 6A is wide, the search range is formed with the search range reflecting Doppler shift (see FIG. 6Aa) due to the movement of the terminal and the search range reflecting an SPS clock source correction error (see FIG. 6Ab), in case where the search range (Δf) of FIG. 6B is narrowed, the search range is formed with the search range reflecting an SPS clock source correction error (see FIG. 6Bb). That is, in case where the moving speed of SPS receiving apparatus mounting mobile communication terminal apparatus 100 is slow, the search range reflecting Doppler shift (see FIG. 6Aa) due to the movement of the terminal, which is used to perform search in the frequency range taking into account the maximum speed at all times, is removed from the search range.

Search frequency controlling section 110 performs search by widening the frequency up and down based on the SPS search reference frequency (fo) determined in frequency correction controlling section 109, and, when the frequency reaches the search range, brings the frequency back to the search reference frequency to continue search. The only difference between FIG. 6A and FIG. 6B is the search range, and the other operations are the same.

The number of searches varies depending on the difference between the above search ranges, and, when the search range is narrower, the number of searches for the same frequency increases. As is clear from comparison between FIG. 6A and FIG. 6B, when the search range (Δf) is narrowed, opportunities for performing searches are twice or more than when the search range (Δf) is wide.

An SPS receiver that people bring assumes that positioning is executed in, for example, a room in which satellite signals are weak, and therefore cannot capture satellite signals at all times in this case even if the search frequency reaches the frequencies of the satellites. Consequently, increasing the opportunities for performing search for the same frequency again and again and capturing signals effectively reduces the time required for positioning, improves the probability of enabling positioning in a specified time, and improves sensitivity. Accordingly, with the present embodiment, it is possible to set a narrow search range and, consequently, reduce the time required for positioning, improve the probability of enabling positioning within the specified time and improve sensitivity.

As explained above in detail, Doppler shift amount measuring means 112a of frequency search range controlling section 112 measures the amounts of Doppler shift of signals from a plurality of base stations in the communication network, and search range controlling means 112b calculates the difference between the maximum value and the minimum value (or the standard deviation or distribution) of the measured amounts of Doppler shift from a plurality of base stations and compares this value with a predetermined threshold, so that SPS receiving apparatus mounting mobile communication terminal apparatus 100 determines the search range upon satellite signal search. Search range controlling means 112b sets a wide search range when deciding that the difference between the maximum value and the minimum value (or the standard deviation or distribution) of the amounts of Doppler shift is greater than the threshold, or sets a narrow search range when deciding that the difference between the maximum value and the minimum value (or the standard deviation or distribution) of the amounts of Doppler shift is smaller than the threshold. As described above, taking the advantage of variations of the received frequencies of base stations due to Doppler shift when the moving speed of the terminal is fast, the SPS search range is controlled based on the amounts of Doppler shift of signals from a plurality of base stations. By this means, when SPS receiving apparatus mounting mobile communication terminal apparatus 100 is not moving, it is possible to increase the number of SPS signal searches per unit time by detecting that SPS receiving apparatus mounting mobile communication terminal apparatus 100 is not moving and by narrowing the search range, and reduce the time required to capture signals by increasing the opportunities for capturing SPS signals. That is, it is possible to reduce the time required for positioning by reducing the time for capturing signals when the terminal is not moving.

Note that, with the present embodiment, although the ratios of oscillation frequencies and received frequencies are used as indicators of the amounts of Doppler shift, the present invention is not limited to this and other indicators representing Doppler shift may be used.

Further, although the difference between the maximum value and the minimum value, standard deviation and distribution are provided as indicators of variations of the frequencies of a plurality of base stations, the present invention is not limited to this, and other indicators may be used.

Furthermore, any method is possible as long as it controls the SPS search range based on the amounts of Doppler shift of signals from a plurality of base stations, the present invention is not limited to the search range narrowing control method of narrowing a search range that is set wide.

### Embodiment 2

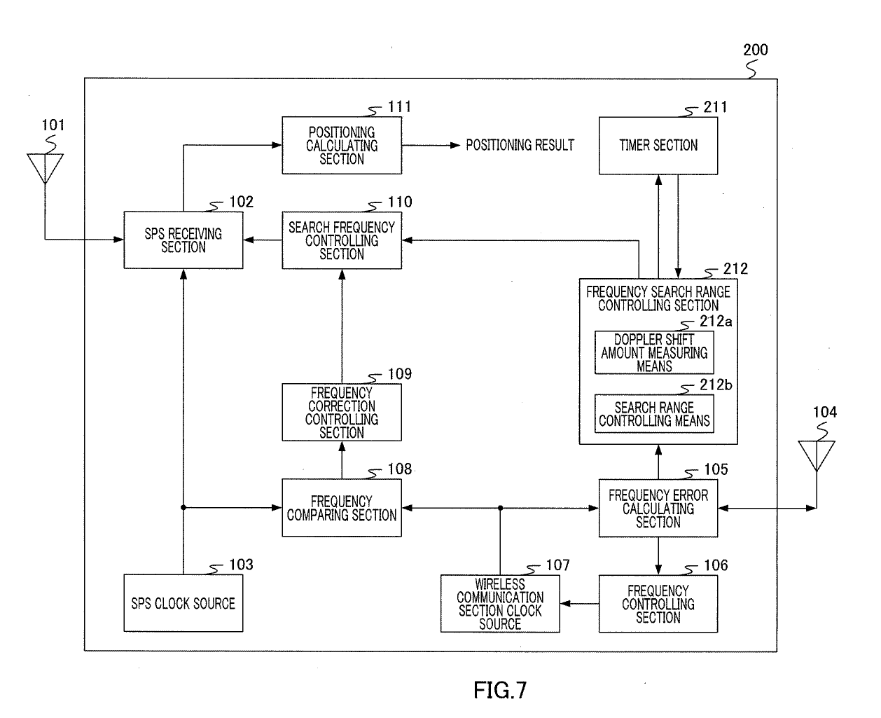

FIG. 7 shows a configuration of a mobile communication terminal apparatus with a positioning receiving apparatus according to Embodiment 2 of the present invention. To explain the present embodiment, the same components as in FIG. 3 will be assigned the same reference numerals, and explanation of overlapping components will be omitted.

In FIG. 7, SPS receiving apparatus mounting mobile communication terminal apparatus 200 has SPS antenna 101, SPS receiving section 102, SPS clock source 103, wireless communication section antenna 104, frequency error calculating section 105, frequency controlling section 106, wireless communication section clock source 107, frequency comparing section 108, frequency correction controlling section 109, search frequency controlling section 110, positioning calculating section 111, timer section 211 and frequency search range controlling section 212.

Similar to SPS receiving apparatus mounting mobile communication terminal apparatus 100 of FIG. 3, SPS receiving apparatus mounting mobile communication terminal apparatus 200 is a mobile telephone with an SPS receiving function or a vehicle navigation apparatus. SPS receiving apparatus mounting mobile communication terminal apparatus 100 is a mobile communication terminal having the function of connecting to the wireless base station and the positioning function based on the SPS receiving system.

The configuration of blocks of SPS receiving apparatus mounting mobile communication terminal apparatus 200 is the same as in FIG. 3 except the blocks of timer section 211 and frequency search range controlling section 212.

Timer section 211 measures the time in which the search range is narrowed, or the time in which the search range is not narrowed.

Frequency search range controlling section 212 has: Doppler shift amount measuring means 212a that measures the amounts of Doppler shift of signals from a plurality of base stations in the communication network; and search range controlling means 212b that controls the search range for positioning satellite signal search based on the measured amounts of Doppler shift of signals from a plurality of base stations, and determines the frequency search range upon SPS signal search utilizing information about the frequency of each base station.

Doppler shift amount measuring means 212a measures variations of the received frequencies between base stations as the amounts of Doppler shift.

Search range controlling means 212b performs search range controls for narrowing the search range when variations of the frequencies between base stations indicated by the measured amounts of Doppler shift of signals from a plurality of base stations are significant, and widening the search range when variations of frequencies between base stations are little.

Search range controlling means 212b narrows the search range when the time measured by timer section 211 exceeds predetermined time. Further, search range controlling means 212b widens the search range when the time measured by timer section 211 exceeds the predetermined time.

Furthermore, similar to search range controlling means 112b of Embodiment 1, search range controlling means 212b performs controls for narrowing the positioning satellite search range (a) in case where the difference between the minimum value and the maximum value of the measured amounts of Doppler shift of signals from a plurality of base stations is equal to or less than a threshold, (b) in case where the standard deviation of the measured amounts of Doppler shift of signals from a plurality of base stations is equal to or less than the threshold or (c) in case where the distribution of the measured amounts of Doppler shift of signals from a plurality of base stations is equal to or less than the threshold.

Hereinafter, the operation of SPS receiving apparatus mounting mobile communication terminal apparatus 200 configured as described above will be explained. The satellite signal searching operation and the basic operation of the search range determining method of SPS receiving apparatus mounting mobile communication terminal apparatus 200 are the same as in Embodiment 1 and therefore explanation thereof will be omitted, and the characteristic operations will be explained.

Search range controlling means 212b of frequency search range controlling section 212 starts the timer of timer section 211 when a narrow frequency search range is set. Timer section 211 starts measuring time, and, after a setting time passes, reports to search range controlling means 212b that the setting time has passed. Search range controlling means 212b sets a wide search range when timer section 211 reports that the setting time has passed.

As described above, with the present embodiment, timer section 211 that measures time in which the search range is narrowed, and search range controlling means 212b widens the search range when the time measured by timer section 211 exceeds a threshold, so that it is possible to prevent the abnormal operation that disables positioning by narrowing the search range erroneously and thereby preventing the search range from reaching the frequencies of satellite signals.

Further, SPS receiving apparatus mounting mobile communication terminal apparatus 200 can make timer section 211 and frequency search range controlling section 212 perform the following operations.

Search range controlling means 212b of frequency search range controlling section 212 starts the timer of timer section 211 when a wide frequency search range is set. Timer section 211 starts measuring time, and reports to search range controlling means 212b that the setting time has passed. Search range controlling means 212b sets a narrow search range when timer section 211 reports that the setting time has passed.

As described above, timer section 211 measures time in which the search range is not narrowed, and search range controlling means 212b narrows the search range when the time measured by timer section 211 exceeds a threshold, so that it is possible to increase the probability of acquiring satellite signals by intensively performing search in a narrow range in case where satellite signals cannot be acquired after performing search in a wide search range for a certain period.

### Embodiment 3

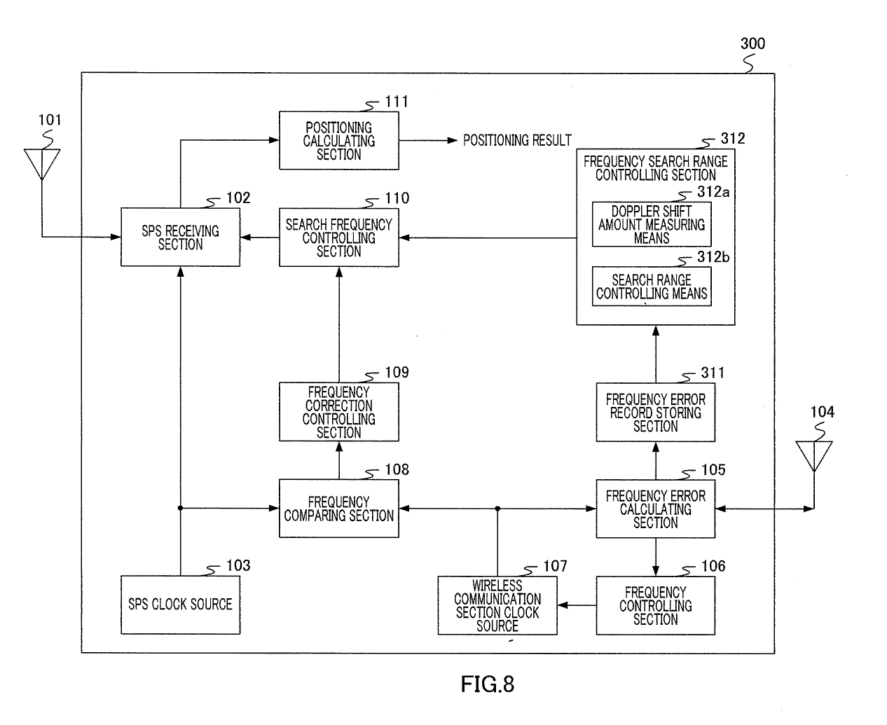

FIG. 8 shows a configuration of a mobile communication terminal apparatus with a positioning receiving apparatus according to Embodiment 3 of the present invention. To explain the present embodiment, the same components as in FIG. 3 will be assigned the same reference numerals, and explanation of overlapping components will be omitted.

In FIG. 8, SPS receiving apparatus mounting mobile communication terminal apparatus 300 has SPS antenna 101, SPS receiving section 102, SPS clock source 103, wireless communication section antenna 104, frequency error calculating section 105, frequency controlling section 106, wireless communication section clock source 107, frequency comparing section 108, frequency correction controlling section 109, search frequency controlling section 110, positioning calculating section 111, frequency error record storing section 311 and frequency search range controlling section 312.

The configuration of blocks of SPS receiving apparatus mounting mobile communication terminal apparatus 300 is the same as in FIG. 3 except the blocks of frequency error record storing section 311 and frequency search range controlling section 312.

Frequency error record storing section 311 stores the record of a certain period in which frequency errors calculated in frequency error calculating section 105 and associated with base stations are found.

Frequency search range controlling section 312 has: Doppler shift amount measuring means 312a that measures the amounts of Doppler shift of signals from a plurality of base stations in the communication network; and search range controlling means 312b that controls the search range for positioning satellite signal search based on the measured amounts of Doppler shift of signals from a plurality of base stations, and determines the frequency search range upon SPS signal search utilizing information about the frequency of each base station.

Doppler shift amount measuring means 312a measures variations of the received frequencies between base stations as the amounts of Doppler shift.

Search range controlling means 312b performs search range controls for narrowing the search range when variations of the frequencies between base stations indicated by the measured amounts of Doppler shift of signals from a plurality of base stations are significant, and widening the search range when variations of frequencies between base stations are little.

Search range controlling means 312b decides whether or not the terminal is moving, with reference to the record of frequency errors stored in frequency error record storing section 311, widens the search range when deciding that the terminal is moving and narrows the search range when deciding that the terminal is not moving.

Hereinafter, the operation of SPS receiving apparatus mounting mobile communication terminal apparatus 300 configured as described above will be explained. The satellite signal searching operation and the basic operation of the search range determining method of SPS receiving apparatus mounting mobile communication terminal apparatus 300 are the same as in Embodiment 1 and therefore explanation thereof will be omitted, and the characteristic operations will be explained.

Frequency error record storing section 311 stores the record of a certain period in which frequency errors calculated in frequency error calculating section 105 and associated with base stations are found. Search range controlling means 312b of frequency search range controlling section 312 decides whether or not the terminal (here, SPS receiving apparatus mounting mobile communication terminal apparatus 300) is moving, with reference to the record of frequency errors. Search range controlling means 312b sets a wide search range when deciding that the terminal is moving and sets a narrow search range when deciding that the terminal is not moving, and reports the set search range to search frequency controlling section 110.

The details of movement detection will be explained.

Frequency error record storing section 311 stores frequency errors associated with base stations at time points T₀, T₁, . . . , and T_{N}. The differences between the maximum values and the minimum values of frequency errors of base stations at time points T₀, T₁, . . . , and T_{N}, are Fe₀, Fe₁, . . . , and Fe_{N}, respectively.

When differences Fe₀, Fe₁, . . . , and Fe_{N} between the maximum values and the minimum values are equal to or greater than a threshold, this indicates that the speed of the terminal with respect to the base station in the communication network changes and therefore search range controlling means 312b decides that the terminal is moving, and, when the differences are equal to or less than the threshold, search range controlling means 312b decides that the terminal is not moving.

As described above, according to the present embodiment, movement is detected based on information about frequency errors in a time sequence, so that it is possible to increase the number of SPS signal searches per unit time by detecting that SPS receiving apparatus mounting mobile communication terminal apparatus 300 is not moving and narrowing the search range, and reduce the time required to capture signals by increasing the opportunities for capturing SPS signals.

For example, if variations of the received frequencies between base stations are distributed in a time sequence, the search range is widened based on the decision that the speed is increased and decreased, and that the terminal is moving. Further, if variations of the received frequencies between base stations are stable in the time sequence, the search range is narrowed based on the decision that the terminal is not moving. In this case, if reception is not possible after the search range is narrowed and then a certain period passes, it is preferable to widen the search range to prevent decision errors.

Further, if variations of received frequencies between base stations are stable in the time sequence, the differences between frequencies of base stations (the differences between frequencies that the base stations originally cause) are stored based on the decision that the terminal is not moving. The stored frequency differences are used as correction values upon calculating variations.

If the terminal is decided to be not moving, by using other sensors (e.g. geomagnetic sensor, acceleration sensor, gyro, camera and illuminometer) or using other sensors in combination, it is possible to improve the accuracy of decision when the terminal is not moving.

Instead of comparing differences Fe₀, Fe₁, . . . , and Fe_{N} between the maximum values and the minimum values, with a threshold, it is equally possible to detect movement by comparing the standard deviation of Fe₀, Fe₁, . . . , and Fe_{N} or the distribution of Fe₀, Fe₁, . . . , and Fe_{N}, with a threshold. Further, the present invention is not limited to this, and other statistical indicators may be used.

Although Fe₀, Fe₁, . . . , and Fe_{N} are the differences between the maximum values and the minimum values of frequency errors associated with base stations at time points T₀, T₁, . . . , and T_{N}, Fe₀, Fe₁, . . . , and Fe_{N} may be the standard deviation or the distribution of frequency errors associated with base stations at time points T₀, T₁, . . . , and T_{N}. Further, the present invention is not limited to this, and other statistical indicators may be used.

Instead of calculating Fe₀, Fe₁, . . . , and Fe_{N} at time points T₀, T₁, . . . , and T_{N}, it is equally possible to compare all items of frequency error data at time points T₀, T₁, . . . , and T_{N}, with a threshold by calculating maximum values and minimum values, or statistical indicators such as the standard deviation and distribution.

Further, the period for performing statistical processing may be varied between the case where a wide search range is set and the case where a narrow search range is set.

### Embodiment 4

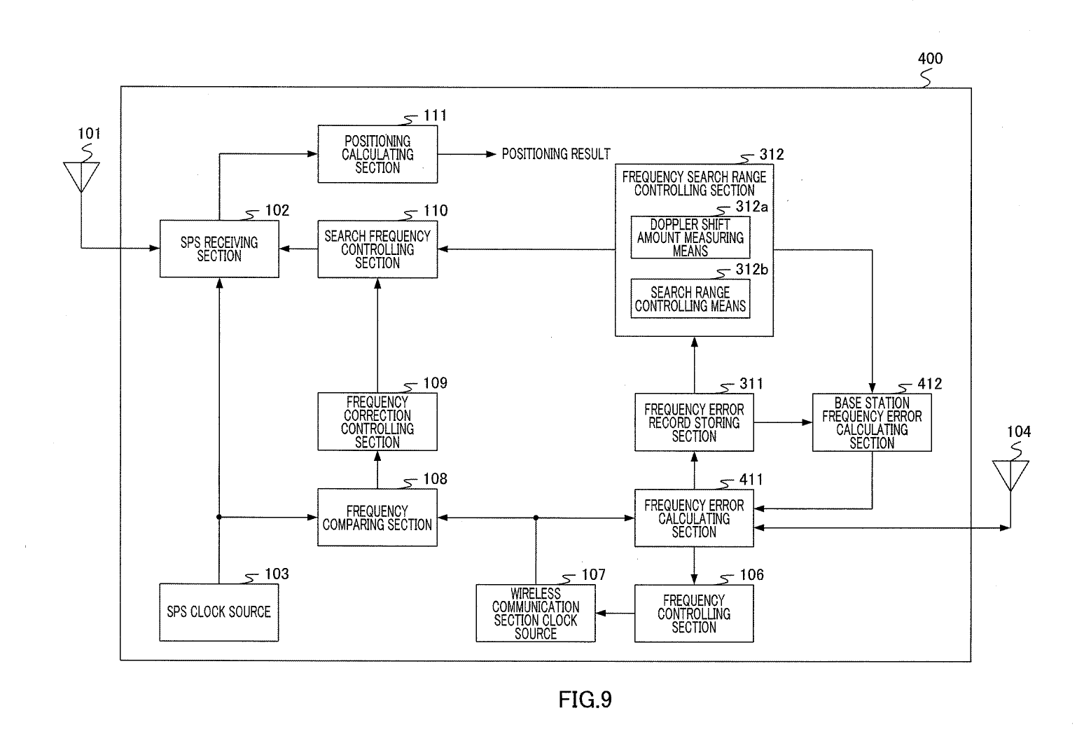

FIG. 9 shows a configuration of a mobile communication terminal apparatus with a positioning receiving apparatus according to Embodiment 4 of the present invention. To explain the present embodiment, the same components as in FIG. 8 will be assigned the same reference numerals, and explanation of overlapping components will be omitted.

In FIG. 9, SPS receiving apparatus mounting mobile communication terminal apparatus 400 has SPS antenna 101, SPS receiving section 102, SPS clock source 103, wireless communication section antenna 104, frequency error calculating section 411, frequency controlling section 106, wireless communication section clock source 107, frequency comparing section 108, frequency correction controlling section 109, search frequency controlling section 110, positioning calculating section 111, frequency error record storing section 311, frequency search range controlling section 312 and base station frequency error calculating section 412.

The configuration of blocks of SPS receiving apparatus mounting mobile communication terminal apparatus 400 is the same as in FIG. 8 except the blocks of frequency error calculating section 411 and base station frequency error calculating section 412.

Frequency error calculating section 411 receives at wireless communication section antenna 104 a signal from a base station in the wireless communication network, and calculates a frequency error of wireless communication clock source 107 based on the frequency of the signal. When calculating a frequency error of wireless communication clock source 107, frequency error calculating section 411 corrects the frequency reflecting the frequency error of each base station calculated in base station frequency error calculating section 412.

Base station frequency error calculating section 412 performs averaging processing with respect to the record of frequency errors associated with base stations and stored in frequency error record storing section 311, and reports the calculated errors to frequency error calculating section 411.

Hereinafter, the operation of SPS receiving apparatus mounting mobile communication terminal apparatus 400 configured as described above will be explained. The satellite signal searching operation and the basic operation of the search range determining method of SPS receiving apparatus mounting mobile communication terminal apparatus 400 are the same as in Embodiment 1. Further, the operation of movement detection is the same as in Embodiment 3, and therefore the characteristic operation will be explained.

Frequency search range controlling section 312 detects movement as explained in Embodiment 3, and further reports to base station frequency error calculating section 412 the result of movement detection. Note that, if the result of movement detection indicates that the terminal is not moving, the observed frequency errors do not reflect Doppler shift due to the movement of the terminal, and therefore are errors included in the signals of the base stations. Hence, according to the following processing, frequency errors of base stations are corrected.

Base station frequency error calculating section 412 applies averaging processing to the record of frequency errors associated with base stations and stored in frequency error record storing section 311, in order to calculate frequency errors of the signals of base stations. This averaging processing may be performed by calculating a total value and dividing the total value by the number of samples or may be performed by using a low pass filter formed with, for example, an FIR filter and IIR filter. Further, instead of performing averaging processing, data at one point in the record may be used as is.

Base station frequency error calculating section 412 reports the errors calculated in this way, to frequency error calculating section 411. Subsequently, to calculate frequency errors of the wireless communication section clock source, frequency error calculating section 411 corrects the frequency for the frequency error of each base station calculated in base station frequency error calculating section 412.

Frequency search range controlling section 312 decides whether or not the terminal is moving, using the corrected frequency errors.

As described above, with the present embodiment, base station frequency error calculating section 412 is provided, so that it is possible to correct frequency errors that base stations cause and detect movement more accurately. By this means, it is possible to make an SPS signal search range more accurate, and further reduce the time required to capture signals.

### Embodiment 5

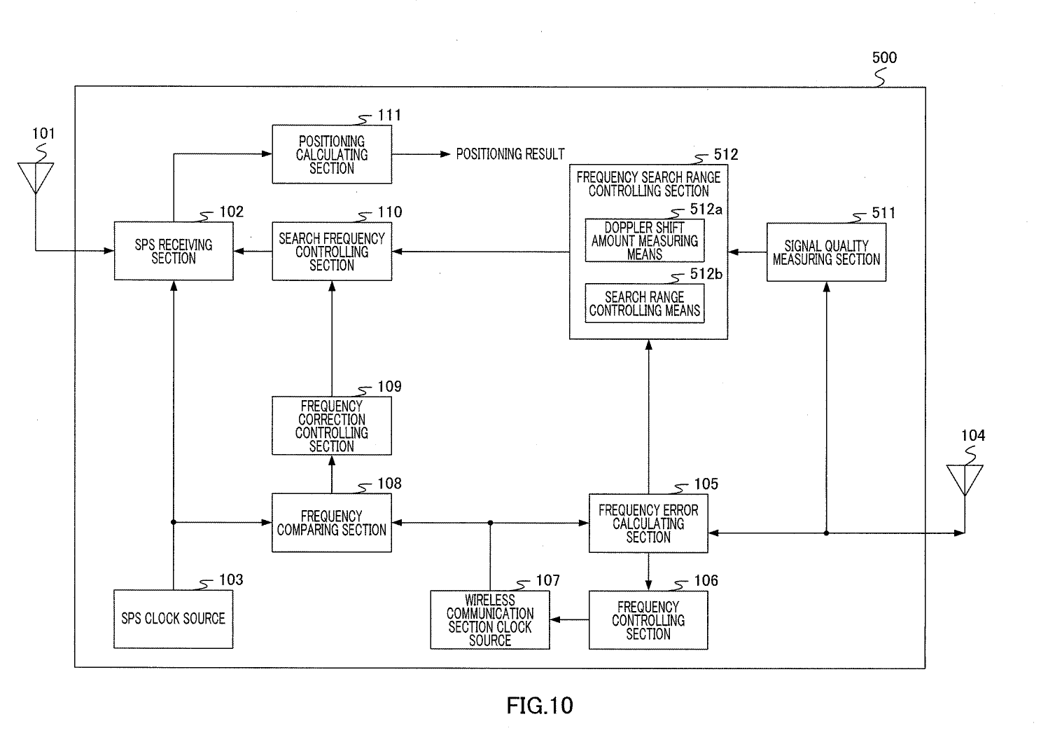

FIG. 10 shows a configuration of a mobile communication terminal apparatus with a positioning receiving apparatus according to Embodiment 5 of the present invention. To explain the present embodiment, the same components as in FIG. 3 will be assigned the same reference numerals, and explanation of overlapping components will be omitted.

In FIG. 10, SPS receiving apparatus mounting mobile communication terminal apparatus 500 has SPS antenna 101, SPS receiving section 102, SPS clock source 103, wireless communication section antenna 104, frequency error calculating section 105, frequency controlling section 106, wireless communication section clock source 107, frequency comparing section 108, frequency correction controlling section 109, search frequency controlling section 110, positioning calculating section 111, signal quality measuring section 511 and frequency search range controlling section 512.

The configuration of blocks of SPS receiving apparatus mounting mobile communication terminal apparatus 500 is the same as in FIG. 3 except the blocks of signal quality measuring section 511 and frequency search range controlling section 512.

Signal quality measuring section 511 decides the quality of signals received from base stations in the communication network. This decision method is performed by comparing the threshold and measured values representing signal quality such as RSCP (Received Signal Code Power), RSSI (Received Signal Strength Indicator), C/N (Carrier to Noise ratio), S/N (Signal to Noise ratio), BER (Bit Error Rate), BLER (Block Error Rate) and Ec/N0 (Signal Energy per chip over Noise Power Spectral Density). Note that parameters representing signal quality are not limited to the above indicators, and other indicators are possible.

Frequency search range controlling section 512 has: Doppler shift amount measuring means 512a that measures the amounts of Doppler shift of signals from a plurality of base stations in the communication network; and search range controlling means 512b that controls the search range for positioning satellite signal search based on the measured amounts of Doppler shift of signals from a plurality of base stations, and determines the frequency search range upon SPS signal search utilizing information about the frequency of each base station.

Doppler shift amount measuring means 512a measures variations of the received frequencies between base stations as the amounts of Doppler shift.

Search range controlling means 512b performs search range controls for narrowing the search range when variations of the frequencies between base station indicated by the measured amounts of Doppler shift of signals from a plurality of base stations are significant, and widening the search range when variations of frequencies between base stations are little.

Furthermore, similar to search range controlling means 112b of Embodiment 1, search range controlling means 512b performs controls for narrowing the positioning satellite search range (a) in case where the difference between the minimum value and the maximum value of the measured amounts of Doppler shift of signals from a plurality of base stations is equal to or less than a threshold, (b) in case where the standard deviation of the measured amounts of Doppler shift of signals from a plurality of base stations is equal to or less than a threshold or (c) in case where the distribution of the measured amounts of Doppler shift of signals from a plurality of base stations is equal to or less than a threshold.

When signal quality measured in signal quality measuring section 511 is equal to or greater than a certain value, search range controlling means 512b controls the search range for positioning satellite signal search based on the amounts of Doppler shift from a plurality of base stations. For example, when search range controlling means 512b calculates (a) the above difference between the maximum value and the minimum value of frequencies of a plurality of base stations or (b) the above standard deviation of frequencies of a plurality of base stations, only signals having certain signal quality (e.g. RSCP, RSSI, C/N, S/N, BER, BLER and Ec/N0) or greater are used. Upon (b) or (c) where the standard deviation or distribution of frequencies of a plurality of base stations are calculated, weight is applied to the standard deviation or distribution of the frequencies of the base stations according to the signal quality (e.g. RSCP, RSSI, C/N, S/N, BER, BLER and Ec/N0).

Hereinafter, the operation of SPS receiving apparatus mounting mobile communication terminal apparatus 500 configured as described above will be explained. The satellite signal searching operation and the basic operation of the search range determining method of SPS receiving apparatus mounting mobile communication terminal apparatus 500 are the same as in Embodiment 1 and therefore explanation thereof will be omitted, and the characteristic operations will be explained.

Signal quality measuring section 511 decides the quality of signals received from base stations in the communication network.

Search range controlling means 512b of frequency search range controlling section 512 determines the search range without using information from base stations of low signal quality. Instead, search range controlling means 512b performs weighting according to signal quality to calculate the standard distribution of frequencies of a plurality of base stations or to calculate the standard deviation or the distribution of the amounts of Doppler shift of frequencies of base stations.

As described above, with the present embodiment, signal quality measuring section 511 that measures the quality of signals received from a plurality of base stations is provided, and search range controlling means 512b controls the search range according to the measured signal quality. For example, assuming that measured values of variations are reliable only when the number of base stations is great and signal quality (e.g. RSSI, C/N, S/N, BER, BLER and Ec/N0) is high, the SPS signal search range is controlled as described in Embodiments 1 to 4, so that it is possible to remove signals from base stations of low quality, from information used to determine the search range, and control the SPS signal search range more accurately. Consequently, it is possible to further reduce the time required to capture signals.

The above explanation is an illustration of a preferable embodiment of the present invention, and the scope of the present invention is not limited to this.

Further, although a case has been explained where the present invention is applied to a mobile communication terminal apparatus with an SPS receiving apparatus, the present invention is not limited to this, and, the present invention is naturally applicable to other various apparatuses that control a search range for positioning satellite signal search based on measured frequencies of a plurality of base stations.

Furthermore, although the names “positioning receiving apparatus,” “mobile communication terminal apparatus” and “a positioning method” are used for ease of explanation, the names “positioning system,” “mobile communication terminal,” “signal capturing method” and the like are naturally possible.

Furthermore, each circuit section constituting the above positioning receiving apparatus, the scheme and the connection method thereof, and types of the SPS receiving section are not limited to the above-described embodiments.

### INDUSTRIAL APPLICABILITY

The positioning receiving apparatus and positioning method according to the present invention are widely applicable not only to a vehicle navigation apparatus in which an SPS receiving apparatus is mounted and a mobile telephone with an SPS receiving function, but is also widely applicable to electric devices that utilize SPS information. The present invention is suitable for use in a positioning receiving apparatus (for example, mobile communication terminal) with a function of capturing signals outputted from positioning satellites (for example, GPS satellites). For example, the present invention is widely applicable not only to GPS and the Galileo system, but is also widely applicable to a plurality of positioning systems such as GLONAS of Russia, WASS of the Untied States of America, MSAS of Japan and EGNOS of Europe that transmit a plurality of satellite signals subjected to spectrum spreading according to a plurality of synchronized modulation codes.

1. A positioning receiving apparatus comprising:
a Doppler shift amount measuring section that measures amounts of Doppler shift of signals from a plurality of base stations;
a search range controlling section that controls a search range for positioning satellite signal search, based on the measured amounts of Doppler shift of the signals from the plurality of base stations; and
a satellite signal searching section that searches for positioning satellite signals in a frequency search range determined in the search range controlling section.

2. The positioning receiving apparatus according to claim 1, wherein, when a difference between a minimum value and a maximum value of the measured amounts of Doppler shift is equal to or less than a threshold, the search range controlling section narrows a positioning satellite search range.

3. The positioning receiving apparatus according to claim 1, wherein, when a standard deviation of the measured amounts of Doppler shift is equal to or less than a threshold, the search range controlling section narrows a positioning satellite search range.

4. The positioning receiving apparatus according to claim 1, wherein, when a distribution of the measured amounts of Doppler shift is equal to or less than a threshold, the search range controlling section narrows a positioning satellite search range.

5. The positioning receiving apparatus according to claim 1, wherein the search range controlling section has a plurality of thresholds used for evaluating the measured amounts of Doppler shift, and controls the search range according to the plurality of thresholds.

6. The positioning receiving apparatus according to claim 1, further comprising a timer that measures time in which the search range is narrowed,
wherein, when the time measured by the timer exceeds a threshold, the search range controlling section widens the search range.

7. The positioning receiving apparatus according to claim 1, further comprising a timer that measures time in which the search range is not narrowed,
wherein, when the time measured by the timer exceeds a threshold, the search range controlling section narrows the search range.

8. The positioning receiving apparatus according to claim 1, further comprising a time-sequential fluctuation calculating section that calculates amounts of time-sequential fluctuation of the measured amounts of Doppler shift,
wherein, when the amounts of time-sequential fluctuation are equal to or less than a threshold, the search range controlling section narrows the search range.

9. The positioning receiving apparatus according to claim 1, further comprising a time-sequential fluctuation calculating section that calculates amounts of time-sequential fluctuation of the measured amounts of Doppler shift,
wherein, when the amounts of time-sequential fluctuation are equal to or less than a threshold, the search range controlling section widens the search range.

10. The positioning receiving apparatus according to claim 9, wherein:
when the amounts of time-sequential fluctuation of the measured amounts of Doppler shift are equal to or less than a threshold, the time-sequential fluctuation calculating section stores frequency errors associated with the base stations; and
the Doppler shift amount measuring section measures the amounts of Doppler shift using the stored frequency errors.

11. The positioning receiving apparatus according to claim 1, further comprising a signal quality measuring section that measures quality of signals received from a plurality of base stations,
wherein the search range controlling section controls the search range according to the quality of the signals measured in the signal quality measuring section.

12. A positioning method comprising:
measuring amounts of Doppler shift of signals from a plurality of base stations;
determining a search range for positioning satellite signal search, based on the measured amounts of Doppler shift of the signals from the plurality of base stations; and
searching for positioning satellite signals in a determined frequency search range.
